(19) United States
(12) Patent Application Publication
(10) Pub. No.: US 2009/0020404 A1
(43) Pub. Date: Jan. 22, 2009

(54) KEYBOARD

(76) Inventor: Kwok Wai Yeung, Hong Kong (CN)

Correspondence Address: SMITH-HILL AND BEDELL, P.C., 16100 NW CORNELL ROAD, SUITE 220, BEAVERTON, OR, 97006, US

(21) Appl. No.: 11/560,419

(22) Filed: Nov. 16, 2006

Related U.S. Application Data
(63) Continuation-in-part of application No. 11/283,181, filed on Nov. 17, 2005, now abandoned.

(51) Int. Cl. H01H 13/74

(52) U.S. Cl. 200/5 E

(57) ABSTRACT

A keyboard is disclosed as including at least a key and two switches associated with each key, in which the key includes at least a first, a second, a third, a fourth, a fifth and a sixth legs, in which only one of the first and second legs is movable to activate a respective of the switches at a time, and the third and fourth legs are movable to each activate a respective of the switches in succession in a first order of activation of the switches, and the said fifth and sixth legs are movable to each activate a respective of the switches in succession in a second order of activation of the switches.

This is a Continuation-In-Part of U.S. patent application Ser. No. 11/283,181 filed on Nov. 17, 2005.

This invention relates to a keyboard, and in particular such a keyboard suitable for inputting characters, commands or instructions to electrical and electronic devices, such as for inputting instructions for navigating in or among various pages and/or menus of electrical and electronic devices (i.e. performing such functions as upward, downward, leftward, rightward, page up, page down, forward, and backward), such as computers, lap top computers, personal digital assistants (PDA's), mobile phones and the like. Such a keyboard may be built-in with the electrical and electronic devices, or may be a separate device connectable to the devices via appropriate interfaces.

There are a large number of electronic and electrical devices provided or connectable with a keyboard with a number of keys for inputting various characters, commands and instructions, e.g. alpha-numeric characters (such as a, b, c, A, B, C, 0, 1, 2, . . . ), symbols (such as %, @, &, . . . ) or characters of various languages (such as Chinese characters, Korean characters or Japanese characters). However, as such devices get smaller and smaller in size, so is the space available for accommodating a keyboard. One way to overcome such a problem is to reduce the size of the keys, but this will increase the chance of errors occurring in operating such a keyboard.

Another possible way to overcome such a problem is to reduce the number of keys, yet maintaining the number of instructions/characters which may be issued or transmitted. This means that the number of instructions/characters which may be issued or transmitted by each key has to be increased. However, to enhance the efficiency of input in such a keyboard, the number of instructions/characters which may be issued or transmitted by each key should be limited. For example, a conventional mobile phone usually contains twelve keys, in which the size of the keyboard is not satisfactory.

It is thus an objective of the present invention to provide a keyboard in which the aforesaid shortcomings are mitigated, or at least to provide a useful alternative to the public.

According to the present invention, there is provided a keyboard including at least a key member and two switches associated with each said key member, wherein said key member includes at least a first, a second, a third, a fourth, a fifth and a sixth contact members, wherein only one of said first and second contact members is movable to activate a respective of said switches at a time, wherein said third and fourth contact members are movable to each activate a respective of said switches in succession in a first order of activation of said switches, and wherein said fifth and sixth contact members are movable to each activate a respective of said switches in succession in a second order of activation of said switches.

Embodiments of the present invention will now be provided, by way of examples only, with reference to the accompanying drawings, in which:

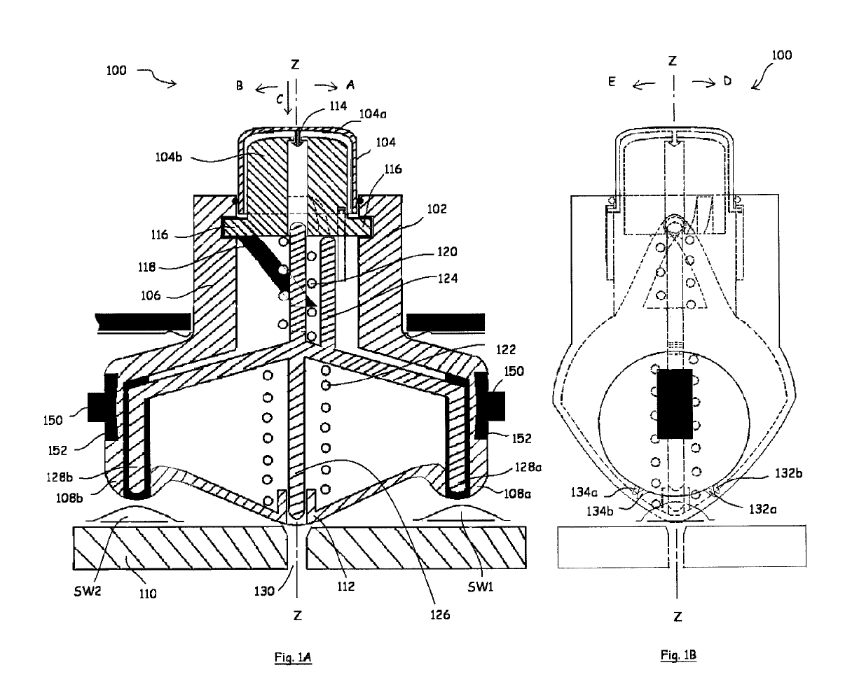

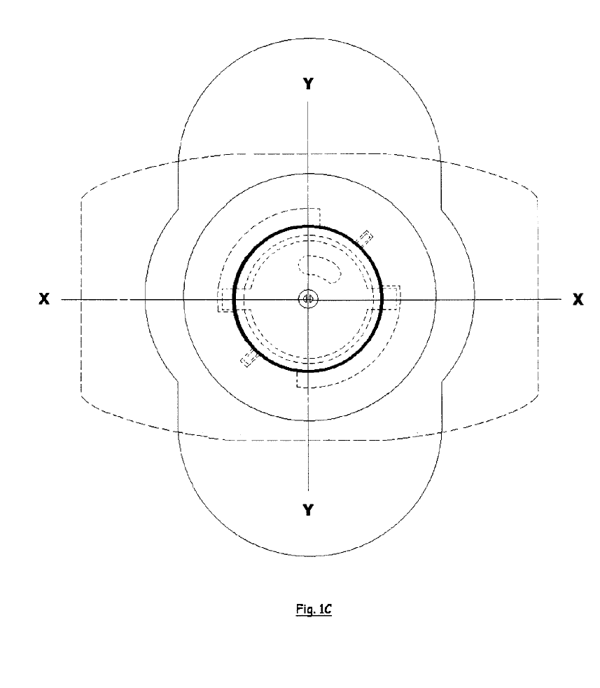

FIG. 1A is a first sectional view of a first exemplary key arrangement forming part of a keyboard according to the present invention;

FIG. 1B is a second sectional view of the key arrangement shown in FIG. 1A;

FIG. 1C is a top view of the key arrangement shown in FIG. 1A;

FIG. 1D is a schematic view showing the position of four of the contact legs of the key and the two switches;

FIG. 1E is a schematic view showing an alternative arrangement of the arrangement of four of the contact legs of the key and the two switches;

FIG. 2A is a first sectional view of a second exemplary key arrangement forming part of a keyboard according to the present invention;

FIG. 2B is a second sectional view of the key arrangement shown in FIG. 2A;

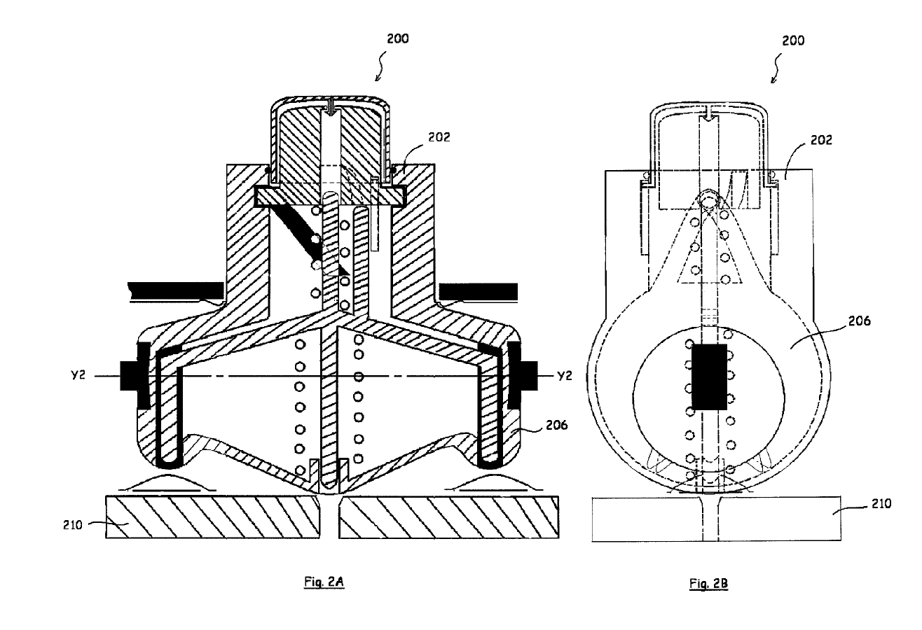

FIG. 3A is a first sectional view of a third exemplary key arrangement forming part of a keyboard according to the present invention;

FIG. 3B is a second sectional view of the key arrangement shown in FIG. 3A;

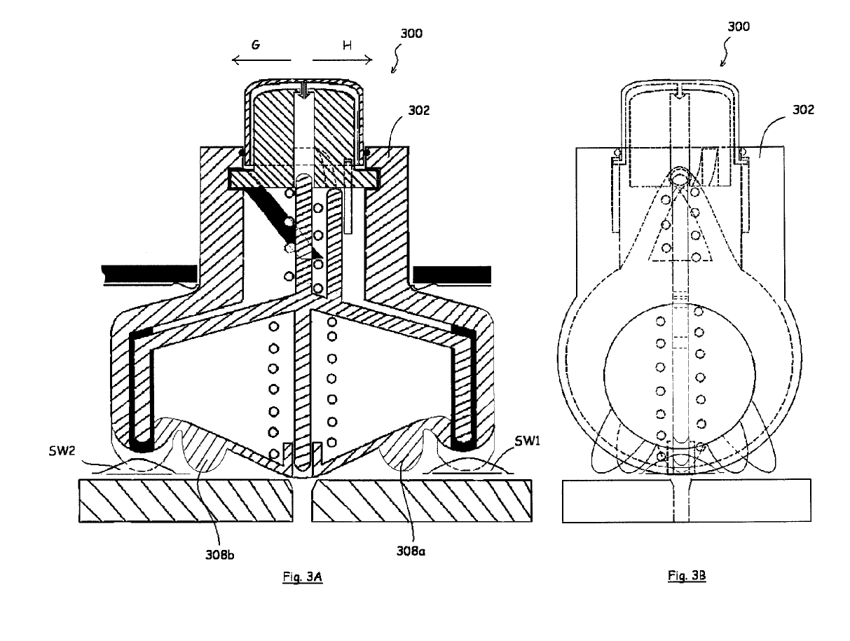

FIG. 4A is the first sectional view of the first exemplary key arrangement shown in FIG. 1A in which the button is at the normal stable position;

FIG. 4B is a partial sectional view of the key arrangement of FIG. 4A in which the button is at a depressed position;

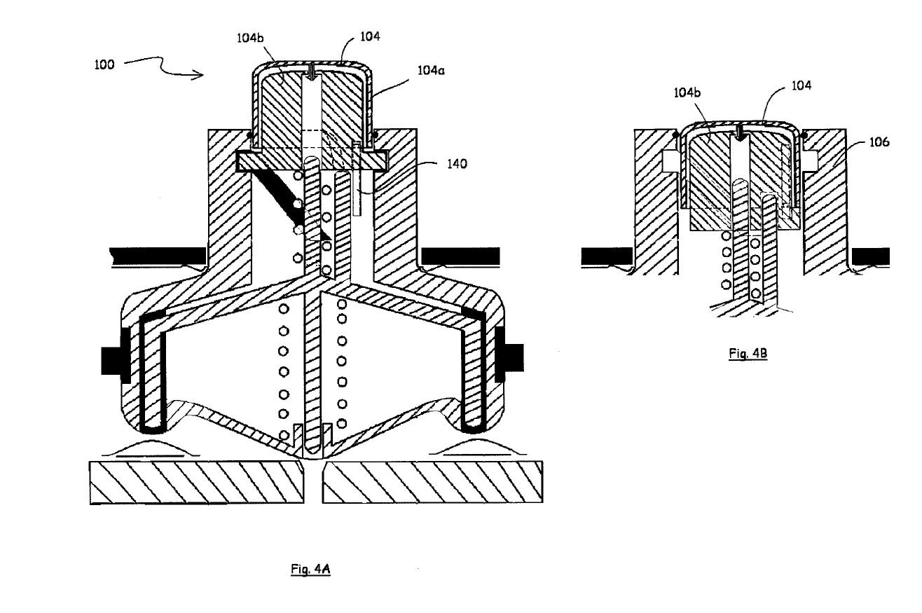

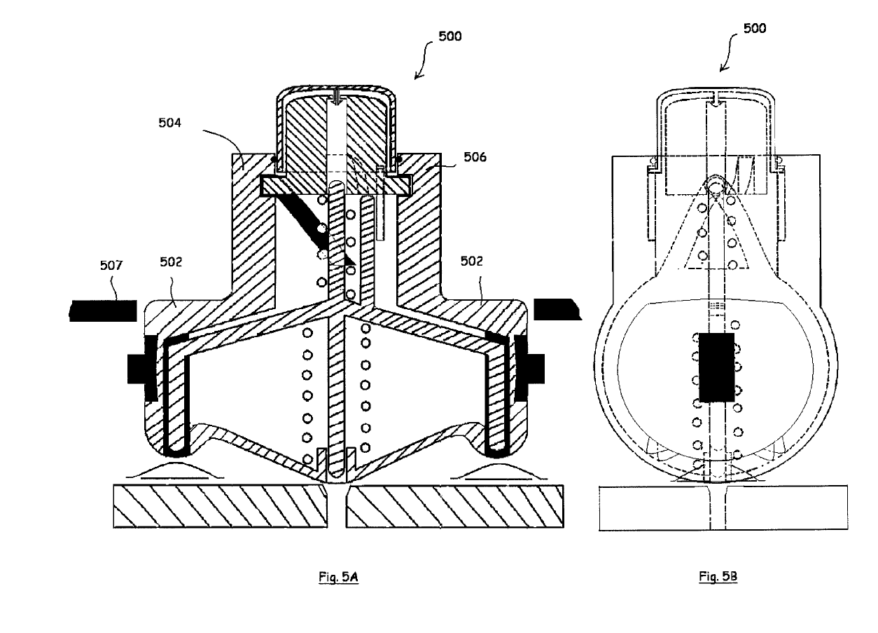

FIG. 5A is a first sectional view of a fourth exemplary key arrangement forming part of a keyboard according to the present invention;

FIG. 5B is a second sectional view of the key arrangement shown in FIG. 5A;

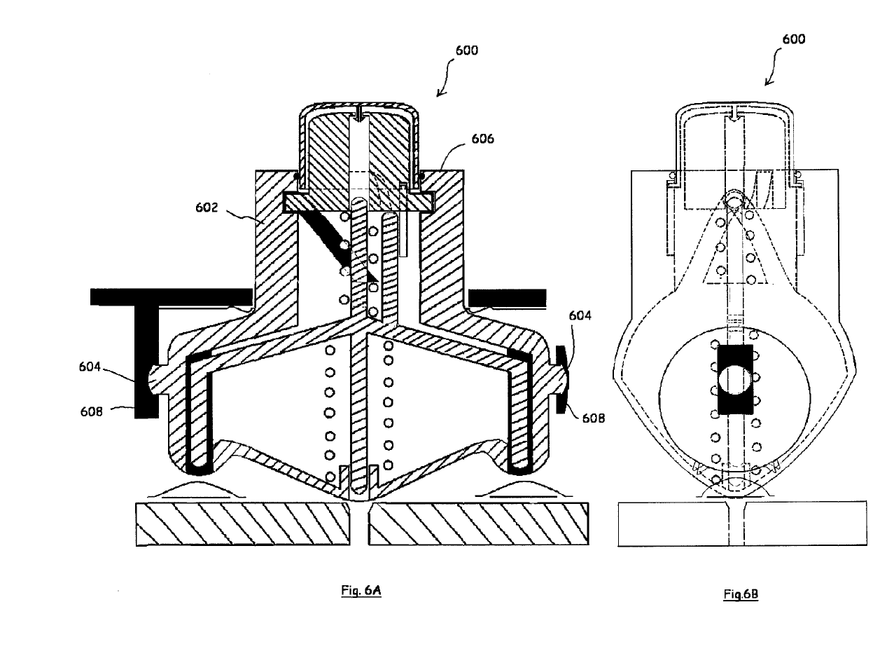

FIG. 6A is a first sectional view of a fifth exemplary key arrangement forming part of a keyboard according to the present invention;

FIG. 6B is a second sectional view of the key arrangement shown in FIG. 6A;

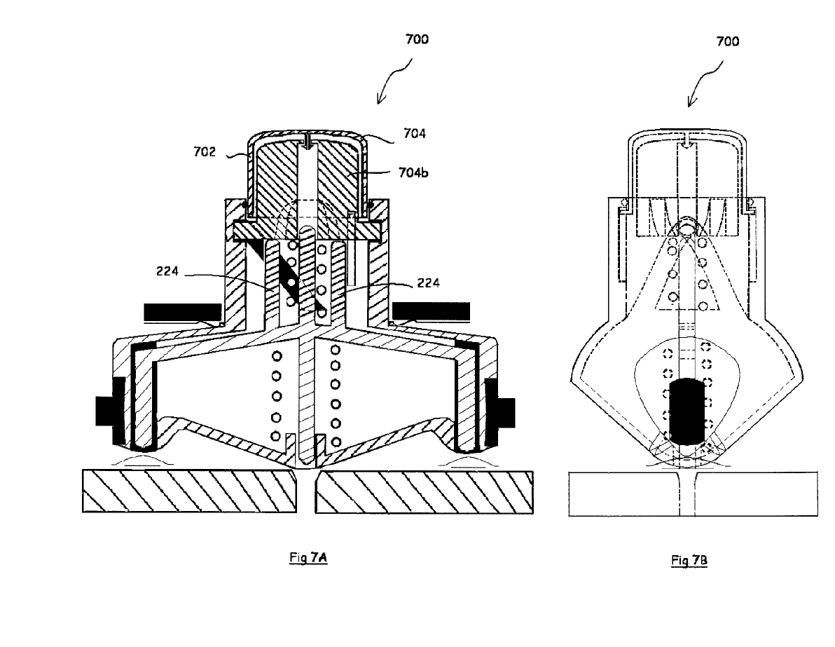

FIG. 7A is a first sectional view of a sixth exemplary key arrangement forming part of a keyboard according to the present invention;

FIG. 7B is a second sectional view of the key arrangement shown in FIG. 7A;

FIG. 8A is a first sectional view of a seventh exemplary key arrangement forming part of a keyboard according to the present invention;

FIG. 8B is a second sectional view of the key arrangement shown in FIG. 8A;

FIG. 9A is a first sectional view of an eighth exemplary key arrangement forming part of a keyboard according to the present invention;

FIG. 9B is a second sectional view of the key arrangement shown in FIG. 9A;

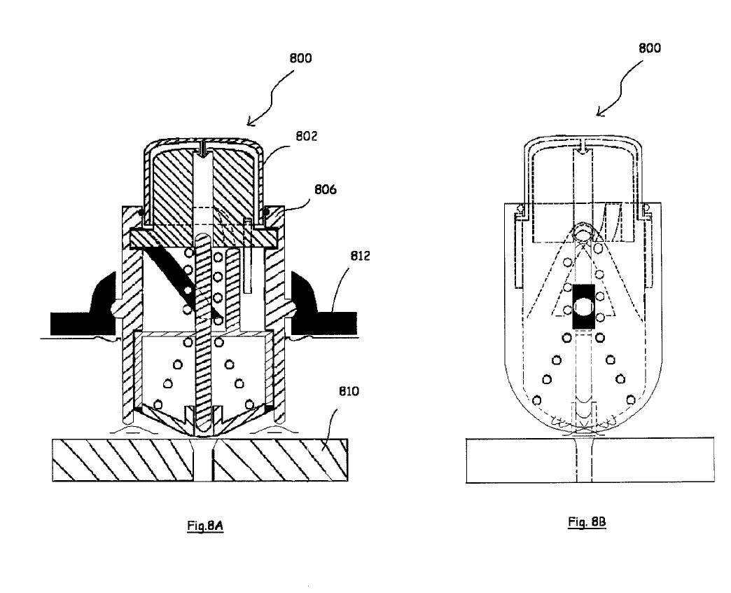

FIG. 10A is a first sectional view of a ninth exemplary key arrangement forming part of a keyboard according to the present invention;

FIG. 10B is a second sectional view of the key arrangement shown in FIG. 10A;

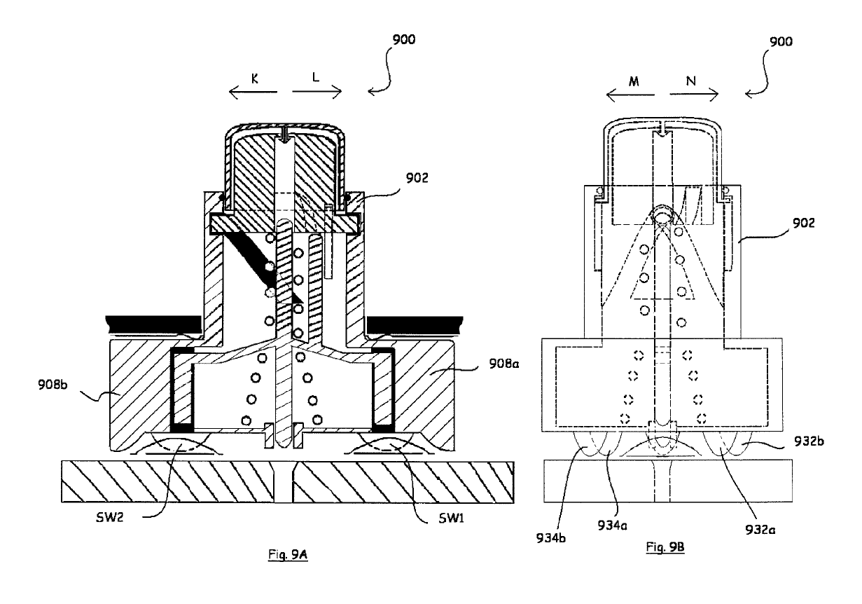

FIG. 11A is a first sectional view of a tenth exemplary key arrangement forming part of a keyboard according to the present invention;

FIG. 11B is a second sectional view of the key arrangement shown in FIG. 11A;

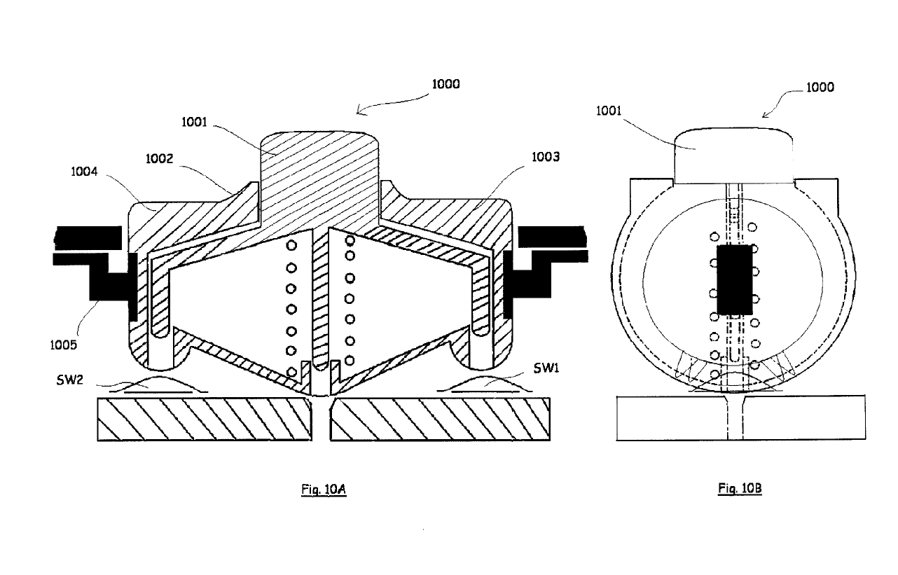

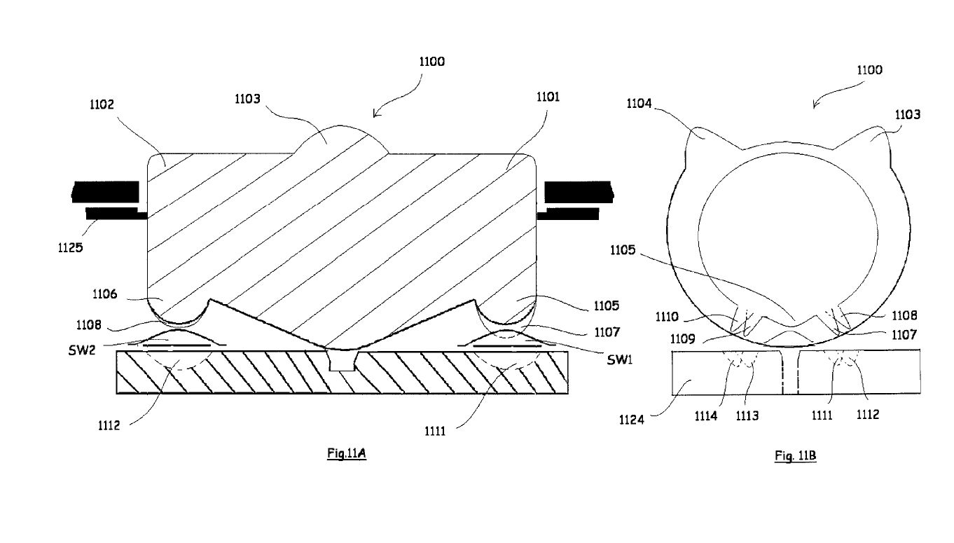

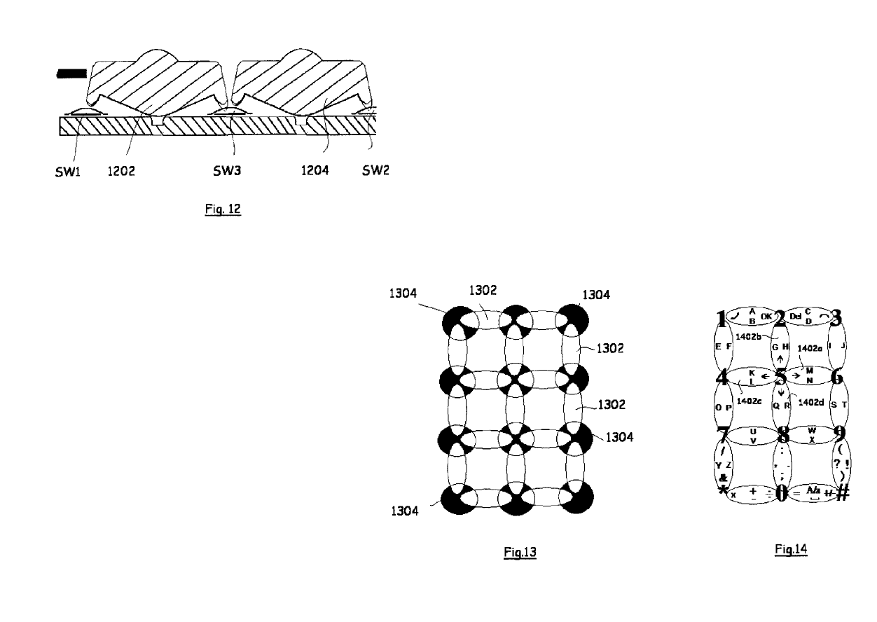

FIG. 12 is a sectional view of an eleventh exemplary key arrangement forming part of a keyboard according to the present invention;

FIG. 13 is a top view of a keyboard arrangement formed of the key arrangement shown in FIG. 12;

FIG. 14 is a top view of a keyboard formed of the key arrangement shown in FIGS. 11A and 11B;

FIG. 15 is a sectional view of a twelfth key exemplary key arrangement forming part of a keyboard according to the present invention;

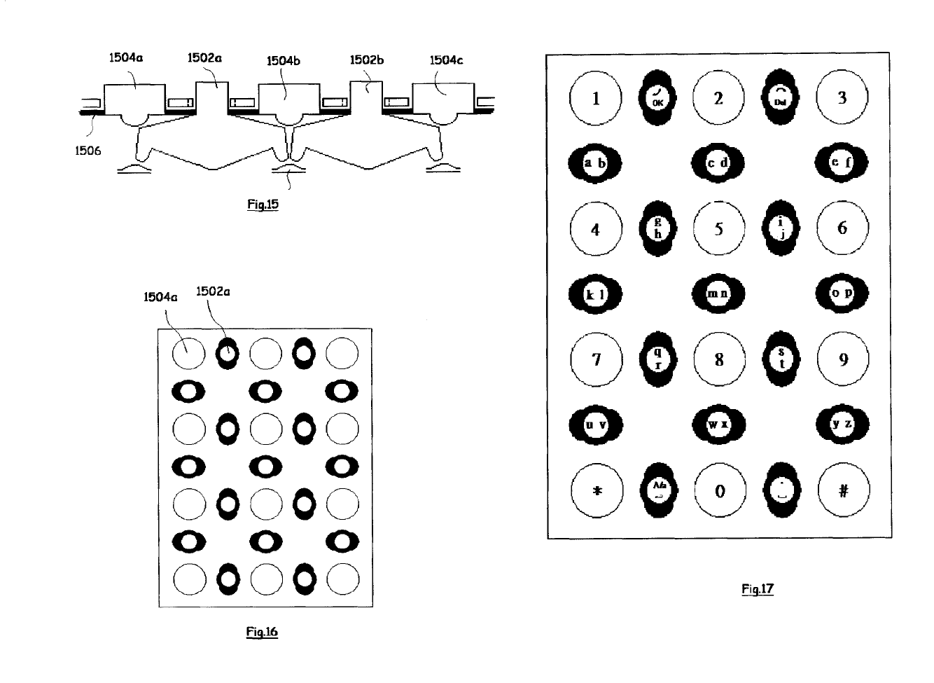

FIG. 16 is a top view of a keyboard formed of the key arrangement shown in FIG. 15; and

FIG. 17 is a further top view of the keyboard shown in FIG. 16 with the keys marked.

As shown in FIGS. 1A to 1C, a first exemplary key arrangement forming part of a keyboard according to the present invention is shown and generally designated as 100. The key arrangement includes a key 102 with a button 104 and a body 106 which are movable relative to each other. Towards a lower end of the body 106 are provided two centrally hollow contact legs 108a, 108b.

A substrate 110 (e.g. a printed circuit board) is positioned below the key 102, and on which are provided two switches (e.g. membrane switches) SW1, SW2, which may be activated (e.g. by being pressed) to issue signals representing a number of different characters.

A narrow protrusion 112 is provided between the legs 108a, 108b. By way of such an arrangement, the key 102 may be swiveled in the direction of the arrow A, about the axis X-X, so that the leg 108a abuts and activates the switch SW1 to issue signals representing a first character, command or instruction. The key 102 may also be swiveled in the direction of the arrow B, about the axis X-X, so that the leg 108b abuts and activates the switch SW2 to issue signal representing a second character, command or instruction. The narrow protrusion 112 will prevent the two legs 108a, 108b from abutting and activating switches SW1 and SW2 simultaneously.

The button 104 has an outer button 104a and an inner button 104b which are connected with each other via a hook arrangement 114 which allows the outer button 104a and inner button 104b to move simultaneously along a path parallel to the axis Z-Z shown in FIGS. 1A and 1B, and at the same time allows the inner button 104b to swivel relative to the outer button 104a about the axis Z-Z, which is perpendicular to the axis X-X.

At a lower end of the inner button 104b are provided with two diametrically opposed extensions 116, each being received within a respective trough 118 on an inner surface of the body 106. As can be seen in FIG. 1A (of which only one trough 118 is shown), the trough 118 extends from an upper part of the inner surface of the body 106 to a lower part thereof through around 90°.

When the button 104 is depressed by a force acting in the direction of the arrow C, and against the upward biasing force of springs 120, 122, while both the inner and outer buttons 104a, 104b will descend into the interior of the body 106, only the inner button 104b will exhibit a rotational movement, as confined by the engagement between the extensions 116 and troughs 118. During such a downward movement of the button 104, a bottom surface of the inner button 104b acts on a free end of a pin 124 to simultaneously bring down a central pin 126 and two contact legs 128a, 128b.

As the central pin 126 is smaller than the diameter of a hole 130 in the substrate 110, if sufficiently depressed, the pin 126 can be partly received within the hole 130, thus allowing the legs 128a, 128b to abut and activate switches SW1 and SW2 simultaneously to issue signals representing a third character, command or instruction.

Once the downward pressing force in the direction of the arrow C is removed, the button 104 (including the outer button 104a and the inner button 104b) will return to the normal stable position (as shown in FIG. 1A) by the upward biasing force of the springs 120, 122.

As shown in FIG. 1B, towards the lower end of the body 106 are provided with two pairs of contact legs 132a, 132b, 134a, 134b, whose positions relative to the switches SW1, SW2 are shown in FIG. 1D. By way of such an arrangement, the key 102 may be swiveled in the direction of the arrow D, about the axis Y-Y, so that the leg 132a abuts and activates the switch SW1 first, to be followed by the leg 132b abutting and activating the switch SW2 in quick succession within a pre-determined period of time, e.g. 0.1 second, to issue signals representing a fourth character, command or instruction. The key 102 may also be swiveled in the direction of the arrow E, about the axis Y-Y, so that the leg 134b abuts and activates the switch SW2 first, to be followed by the leg 134a abutting and activating the switch SW1 in quick succession within a pre-determined period of time, e.g. 0.1 second, to issue signals representing a fifth character. The axis Y-Y is perpendicular to both the axes X-X and Z-Z. If either movement in the D or E directions is required, the protrusion 112 may be wider to act as a support, in order to keep the body of the key stable and in balance.

By way of such an arrangement, signals representing a total of nine different characters, commands, or instructions may be transmitted for input into an electrical or electronic device installed with a keyboard according to the present invention by operating a single key 102, as shown in Table 1 below. For ease of reference, the following symbols are used in the following Table 1:

X+ movement of the key 102 in the direction of the arrow A
X− movement of the key 102 in the direction of the arrow B
Y+ movement of the key 102 in the direction of the arrow D
Y− movement of the key 102 in the direction of the arrow E
Z movement of the key 102 in the direction of the arrow C

TABLE 1

| | | Exemplary Characters, |
|---|---|---|
| Sequence of Movement | Sequence of Switches | Commands or Instructions |
| of the Key | Activated | Inputted |
| X+ | SW1 | A / Rightward / P, Q, R / . . . |
| X− | SW2 | B / Leftward / G, H, I, / . . . |
| Y+ | SW1 followed by SW2 within a | C / Upward/A, B, C, / . . . |
| | pre-determined period of time | |
| Y− | SW2 followed by SW1 within a | D / Downward / V, W, X |
| | pre-determined period of time | / . . . |
| Z | SW1 and SW2 simultaneously | E / OK / M, N, O, / . . . |
| Z + X+ | (SW1 and SW2 simultaneously) | F / Backward /J, K, L/ . . . |
| | followed by SW1 | |
| Z + X− | (SW1 and SW2 simultaneously) | G / Forward / S, T, U / . . . |
| | followed by SW2 | |
| Z + Y+ | (SW1 and SW2 simultaneously) | H / Page Up / D, E, F / . . . |
| | followed by SW1, and subsequently | |
| | by SW2 within a pre-determined | |
| | period of time | |
| Z + Y− | (SW1 and SW2 simultaneously) | I / Page Down / Y, Z / . . . |
| | followed by SW2, and subsequently | |
| | by SW1 within a pre-determined | |
| | period of time | |

It can be seen that after the button 104 is brought to the lower position so that the legs 128a, 128b act on the switches SW1, SW2 simultaneously, the key 102 may be further manipulated to activate the switches SW1, SW2 to transmit signals representing from a sixth to a ninth character, command or instruction.

FIGS. 2A and 2B show a second exemplary key arrangement forming part of a keyboard according to the present invention, generally designated as 200. A key 202 of this arrangement is very similar to the key 102 of the arrangement 100 discussed above. The main difference is that the lower portion of a body 206 of the key 202 is generally of a cylindrical shape, such that the outer surface of the lower portion of the body 206 will abut and slide on the upper surface of a substrate 210 during swiveling movement of the key 202 about the axis Y₂-Y₂ as shown in FIG. 2A. Turning to FIGS. 3A and 3B, a third exemplary key arrangement forming part of a keyboard according to the present invention is shown and generally designated as 300. A main difference between this arrangement 300 and the two arrangements 100, 200 discussed above is that a key 302 includes two legs 308a, 308b inner of the two switches SW1, SW2. It can be seen that in the position as shown in FIG. 3A, neither of the legs 308a, 308b abuts or activates the two switches SW1, SW2. When the key 302 is slid in the direction indicated by the arrow H relative to the switches SW1, SW2, the leg 308a will abut and activate the switch SW1, whereas when the key 302 is slid in the direction indicated by the arrow G relative to the switches SW1, SW2, the leg 308b will abut and activate the switch SW2. Because of the distance between the legs 308a, 308b, they cannot abut and activate the two switches SW1, SW2 simultaneously.

FIG. 4A is essentially the same as FIG. 1A, in which the button 104 is at the normal stable position, whereas FIG. 4B is a partial sectional view of the key arrangement 100 in which the button 104 is at a depressed position, when it descends into the interior of the body 106. It can be seen that when the button 104 is depressed from the position as shown in FIG. 4A to that in FIG. 4B, the inner button 104b has swiveled by around 90°. A vertical trough 140 is provided on an inner surface of the body 106 for receiving a free end of an extension (not shown) of the outer button 104a, so as to prevent swiveling movement of the outer button 104a during its movement.

Turning now to FIGS. 5A and 5B, which show a fourth exemplary key arrangement forming part of a keyboard according to the present invention, and generally designated as 500. A main difference between this key arrangement 500 with the key arrangements 100, 200, 300 discussed above is that shoulders 502 of a body 506 of a key 504 of the key arrangement 500 are exposed to the outside environment. In particular, in this arrangement 500, the upper surfaces of the shoulders 502 are generally co-planar with an upper surface 506 of the electronic or electrical device, or the housing of the key.

FIGS. 6A and 6B show a fifth exemplary key arrangement forming part of a keyboard according to the present invention, and generally designated as 600. This arrangement 600 is very similar to the arrangement 100 shown in FIGS. 1A to 1D. In the arrangement 100, two opposite pins 150 are each received within a recess 152 on opposite sides of the body 106 for swiveling movement of the key 102 about the axis Y-Y. On the other hand, in the key arrangement 600, a body 606 of the key 602 is provided with two opposite pins 604, each being received within a respective recess 608 of part of the electronic or electrical device, or the housing of the key, for swiveling movement about an axis passing through the pins 604.

FIGS. 7A and 7B show a sixth exemplary key arrangement forming part of a keyboard according to the present invention, and generally designated as 700. This arrangement 700 is very similar to the arrangement 100 shown in FIGS. 1A to 1D, except that below an inner button 704b of a button 704 of a key 702 are two pins 224, for simultaneous movement with the inner button 704b.

FIGS. 8A and 8B show a seventh exemplary key arrangement forming part of a keyboard according to the present invention, and generally designated as 800. This arrangement 800 can be said to be a revised version of the key arrangement 200. A first difference is that the pivotal axis of swiveling of the key 802 relative to the substrate 810 is raised to close to or above an upper surface 812 of the electrical or electronic device. A second difference is that the width of the body 806 of the key 802 is generally uniform along its whole vertical length.

FIGS. 9A and 9B show an eighth exemplary key arrangement forming part of a keyboard according to the present invention, and generally designated as 900, which can be said to be a variation of the key arrangement 300 shown in FIGS. 3A and 3B. In the arrangement 300, the legs 308a, 308b are inner of the two switches SW1, SW2. On the other hand, in the arrangement 900, legs 908a, 908b of a key 902 are outer of the two switches SW1, SW2. It can be seen that in the position as shown in FIG. 9A, neither of the legs 908a, 908b abuts or activates the two switches SW1, SW2.

When the key 902 is slid in the direction indicated by the arrow L relative to the switches SW1, SW2, the leg 908b will abut and activate the switch SW2, whereas when the key 902 is slid in the direction indicated by the arrow K relative to the switches SW1, SW2, the leg 908a will abut and activate the switch SW1. Because of the distance between the legs 908a, 908b, they cannot abut and activate the two switches SW1, SW2 simultaneously.

Similarly, when the key 902 is slid in the direction indicated by the arrow M relative to the switches SW1, SW2, legs 932a, 932b respectively acts on the switches SW1 and SW2 in succession. When the key 902 is slid in the direction indicated by the arrow N relative to the switches SW1, SW2, legs 934a, 934b respectively acts on the switches SW2 and SW1 in succession.

Turning to FIGS. 10A and 10B, such show a ninth exemplary key arrangement forming part of a keyboard according to the present invention, and generally designated as 1000. This arrangement 1000 is similar to the key arrangement 500 shown in FIGS. 5A and 5B and discussed above, with the main difference being that a button 1001 in the arrangement 1000 does not include any inner button and the button 1001 only protrudes slightly above shoulders 1003, 1004 of a body 1002. Such an arrangement facilitates pressing of shoulders 1003, 1004 of the body 1002 to activate switches SW1, SW2.

FIGS. 11A and 11B show a tenth exemplary key arrangement forming part of a keyboard according to the present invention, generally designated as 1100. Two protrusions 1103, 1104 extend upwardly from an upper surface of the key 1120 and generally away from each other, for operation purposes. A finger of a user may manipulate the key 1120 by acting on the protrusions 1103, 1104 and shoulders 1101, 1102 of the key 1120 to move legs 1105, 1106, 1107, 1108, 1109, 1110 to activate switches SW1, SW2.

Such an arrangement reduces the production cost, and enhances operation of the key 1120 as the finger of the user may slide across the upper surface of the key 1120 among the various action areas, namely protrusions 1103, 1104 and shoulders 1101, 1102. Supports 1125 are made of an elastic material, such as the same as that of supports 1005 shown in FIG. 10A, e.g. rubber, to also serve to maintain the key 1120 at a normal upright position relative to the switches SW1, SW2.

A major difference between this key arrangement 1100 and the key arrangement 1000 is that the key 1120 of the arrangement 1100 is made of a unitary whole with no relatively movable part. In particular, it can be seen that the protrusions 1103, 1104 and the legs 1105, 1106, 1107, 1108, 1109, 1110 are integral with a body 1122 of the key 1120. The production cost of the key 1120 is thus reduced.

In a substrate 1124 supporting the switches SW1, SW2 are formed a number of recesses 1111, 1112, 1113, 1114 positioned, sized, and configured for each receiving a respective of the legs 1107, 1108, 1109, 1110, when the shoulders 1101, 1102 are active. As the legs 1107, 1108, 1109, 1110 are closer to the legs 1105, 1106, they will be lower than the legs 1105, 1106. Less turning movement of the key body 1120 is therefore required.

For better understanding of the operation of the key arrangement 1100, exemplary signals and sequences of acting the various action areas are shown in the following Table 2:

TABLE 2

| | | Exemplary |
|---|---|---|
| | | Characters, |
| Sequence of | | Commands or |
| Acting on the | Sequence of Switches | Instructions |
| Action Areas | Activated | Inputted |
| 1101 | (SW1) | 1 |
| 1102 | (SW2) | 2 |
| 1103 | (SW1→SW2) | 3 |
| 1104 | (SW2→SW1) | 4 |
| 1101→1102 | (SW1)→(SW2) | 5 |
| 1102→1101 | (SW2)→(SW1) | 6 |
| 1101→1103 | (SW1)→(SW1→SW2) | 7 |
| 1101→1104 | (SW1)→(SW2→SW1) | 8 |
| 1102→1103 | (SW2)→(SW1→SW2) | 9 |
| 1102→1104 | (SW2)→(SW2→SW1) | 10 |
| 1103→1101 | (SW1→SW2)→(SW1) | 11 |
| 1103→1102 | (SW1→SW2)→(SW2) | 12 |
| 1104→1101 | (SW2→SW1)→(SW1) | 13 |
| 1104→1102 | (SW2→SW1)→(SW2) | 14 |
| 1103→1104 | (SW1→SW2)→(SW2→SW1) | 15 |
| 1104→1103 | (SW2→SW1)→(SW1→SW2) | 16 |

When the protrusions 1103, 1104 are actioned, the switches SW1, SW2 will be activated in quick succession within a pre-determined period of time, e.g. 0.1 second. If an action area is pressed down and the finger of the user slides to another action area for further action, the pre-determined period of time is longer, e.g. within 0.5 second.

It is envisaged as part of the present invention that a switch may be shared by two or more keys, in the sense that more than one key may activate the same switch. A further key arrangement forming part of a keyboard according to the present invention is shown in FIG. 12 in which two keys 1202, 1204 (each similar in structure an appearance as the key 1120 in the arrangement 1100 discussed above) are shown. It can be seen that while a switch SW1 can only be activated by operating the key 1202, and a switch SW2 can only be activated by operating the key 1204, a switch SW3 may be operated by either of the two keys 1202, 1204.

A schematic diagram of a keyboard formed of the key arrangement shown in FIG. 12 is shown in FIG. 13, in which the generally oval parts 1302 represent keys and the circular parts 1304 represent switches. It can be seen that all the switches 1304 are shared by at least two keys 1302, some of the switches 1304 are shared by three keys 1302, and a number of switches 1304 are shared by four keys 1302. With such an arrangement, the number of switches 1304 is less than that of the keys 1302, without jeopardizing the number of characters, commands or instructions which may be generated by operating the keyboard.

FIG. 14 shows the keys 1302 as marked or labeled to indicate the characters, commands or instructions which may be generated by operation of the keys 1302. It can be seen that in some cases, the character, command or instruction may be generated or inputted into the electrical/electronic device by operating several different sequences of acting on the various action areas. For example, for inputting the numeral “5”, the leftward end of the key 1402a may be actioned, and the a finger of a user is moved to the rightward end of the key 1402a within 0.5 second, the downward end of the key 1402b may be actioned and the finger is moved to the upward end of the key 1402b within 0.5 second, the rightward end of the key 1402c may be actioned and then the finger is moved to the leftward end of the key 1402c within 0.5 second, or the upward end of the key 1402d may be actioned, and then the finger is moved to the downward end of the key 1402d within 0.5 second.

A yet further key arrangement forming part of a keyboard according to the present invention is shown in FIG. 15. In this arrangement, in addition to a number of keys 1502a, 1502b which may be similar in structure and appearance to the key 106 in the arrangement 100 discussed above, the key arrangement may be constructed without the top button, but with a number of secondary keys 1504a, 1504b, 1504c are provided. Taking the secondary key 1504b as an example, this key may be actioned to act on the right leg of the key 1502a and the left leg of the key 1502b to simultaneously activate a shared switch SW1. An elastic material (e.g. rubber) 1506 is provided for locating the keys 1502a, 1502b and the secondary keys 1504a, 1504b, 1504c.

A schematic diagram of a keyboard formed of the key arrangement shown in FIG. 15 and discussed above is shown in FIG. 16. As shown in further detail in FIG. 17, the upper surface of the keys 1502a, 1502b and the secondary keys 1504a, 1504b, 1504c are marked or labeled to show the characters, numerals, instructions and/or commands which would be issued upon action of the respective keys and secondary keys, so as to facilitate operation of the keyboard, without having to change the inputting mode for characters, numerals, instructions and/or commands.

It should be understood that the above only illustrates examples whereby the present invention may be carried out, and that various modifications and/or alterations may be made thereto without departing from the spirit of the invention.

It should also be understood that certain features of the invention, which are, for clarity, described in the context of separate embodiments, may be provided in combination in a single embodiment. Conversely, various features of the invention which are, for brevity, described in the context of a single embodiment, may also be provided separately or in any appropriate sub-combinations.

1. A keyboard including at least a key member and two switches associated with each said key member, wherein said key member includes at least a first, a second, a third, a fourth, a fifth and a sixth contact members, wherein only one of said first and second contact members is movable to activate a respective of said switches at a time, wherein said third and fourth contact members are movable to each activate a respective of said switches in succession in a first order of activation of said switches, and wherein said fifth and sixth contact members are movable to each activate a respective of said switches in succession in a second order of activation of said switches.

2. A keyboard according to claim 1 wherein said third and fourth contact members are swivellably movable about a first axis to each activate a respective of said switches in succession in said first order of activation of said switches.

3. A keyboard according to claim 2 wherein said fifth and sixth contact members are swivellably movable about said first axis to each activate a respective of said switches in succession in a second sequence of activation of said switches.

4. A keyboard according to claim 1 further including a seventh and an eighth contact members which are movable to each activate a respective of said switches simultaneously.

5. A keyboard according to claim 4 wherein said seventh and eighth contact members are operatively associated with a button member of said key member.

6. A keyboard according to claim 5 wherein said button member is movable relative to a body member of said key member between a first position in which said seventh and eighth contact members are out of contact with said switches and a second position in which said seventh and eighth contact members abut said switches.

7. A keyboard according to claim 6 wherein said button member is biased towards said first position.

8. A keyboard according to claim 7 wherein said button member is biased towards said first position by a spring means.

9. A keyboard according to claim 1 further including means adapted to prevent said first and second contact members from being movable to activate said switches simultaneously.

10. A keyboard according to claim 1 wherein said first contact member is movable to activate a first of said switches to transmit signals representing a first character, command or instruction.

11. A keyboard according to claim 1 wherein said second contact member is movable to activate a second of said switches to transmit signals representing a second character, command or instruction.

12. A keyboard according to claim 4 wherein said seventh and eighth contact members are movable to activate said switches simultaneously to transmit signals representing a third character, command or instruction.

13. A keyboard according to claim 1 wherein said third and fourth contact members are movable to each activate a respective of said switches in succession in said first order of activation of said switches to transmit signals representing a fourth character, command or instruction.

14. A keyboard according to claim 1 wherein said fifth and sixth contact members are movable to each activate a respective of said switches in succession in said second order of activation of said switches to transmit signals representing a fifth character, command or instruction.

15. A keyboard according to claim 1 wherein said first and second contact members are swivellably movable about a second axis to each activate a respective of said switches.

16. A keyboard according to claim 1 wherein said first and second contact members are slidably movable relative to said switches in a first direction to abut and activate a first of said switches, and are slidably movable relative to said switches in a second direction to abut and activate a second of said switches.

17. A keyboard according to claim 4 wherein said seventh and eighth contact members are movable substantially parallel to a third axis to activate said switches simultaneously.

18. A keyboard according to claim 17 wherein said third axis is substantially perpendicular to said first axis.

19. A keyboard according to claim 4 wherein signals representing a sixth character, command or instruction are adapted to be transmitted upon activation of said switches simultaneously by said seventh and eighth contact members, followed by activation of one of said switches by said first contact member within a pre-determined period of time.

20. A keyboard according to claim 4 wherein signals representing a seventh character, command or instruction are adapted to be transmitted upon activation of said switches simultaneously by said seventh and eighth contact members, followed by activation of one of said switches by said second contact member within a pre-determined period of time.

21. A keyboard according to claim 4 wherein signals representing an eighth character, command or instruction are adapted to be transmitted upon activation of said switches simultaneously by said seventh and eighth contact members, followed by activation of said switches in succession in said first order by said third and fourth contact members within a pre-determined period of time.

22. A keyboard according to claim 4 wherein signals representing a ninth character, command or instruction are adapted to be transmitted upon activation of said switches simultaneously by said seventh and eighth contact members, followed by activation of said switches in succession in said second order by said fifth and sixth contact members within a pre-determined period of time.

23. A keyboard according to claim 5 wherein said button member includes an outer part and an inner part in which said inner part is swivelably movable relative to said outer part during movement of said button member relative to said body member between said first position and said second position.

24. A keyboard according to claim 23 wherein during movement of said button member relative to said body member between said first position and said second position, said outer part is slidably movable relative to said body member and said inner part is slidably and swivelably movable relative to said body member.

25. A keyboard according to claim 24 wherein during movement of said button member relative to said body member between said first position and said second position, said inner part is swivelably movable relative to said body member through an angle of up to substantially 90°.

26. A keyboard according to claim 1 wherein said key member is of a unitary structure.

27. A keyboard according to claim 26 wherein said contact members are integral with a body member of said key member.

28. A keyboard according to claim 27 wherein said key member includes two protrusions extending generally upwardly from an upper surface of said body member.

29. A keyboard according to claim 28 wherein said protrusions extend generally away from each other.

30. A keyboard according to claim 28 wherein said protrusions are integral with said body member.

31. A keyboard according to claim 1 further including at least two key members, wherein at least one switch is activatable by said at least two key members.

32. A keyboard according to claim 31 wherein said at least one switch is activatable by at least three key members.

33. A keyboard according to claim 32 wherein said at least one switch is activatable by at least four key members.

34. A keyboard according to claim 31 further including at least one key member operable to act on at least two key members to activate a switch member.

35. A keyboard according to claim 1 wherein in at least one of said first and second orders of activation of said switches, said switches are adapted to be activated simultaneously.
